(19) United States
(12) Patent Application Publication
(10) Pub. No.: US 2023/0151954 A1
(43) Pub. Date: May 18, 2023

(54) Power Adapter of LED Light String Having Valley-fill Circuit

(71) Applicant: Guang Zhou Ting Shen Electric Co., Ltd., Guang zhou (CN)

(72) Inventor: Chia-Chun WANG, Hsinchu County (TW)

(21) Appl. No.: 17/529,806

(22) Filed: Nov. 18, 2021

(51) Int. Cl. F21V 23/02; H02M 1/12; H02M 7/06; H05B 45/37

(52) U.S. Cl. CPC F21V 23/026; H02M 1/126; H02M 7/06; H05B 45/37; F21Y 2115/10

(57) ABSTRACT

A power adapter of an LED light string having a valley-fill circuit contains: a casing and a plug fixed on the casing. The casing includes an energy-saving circuit board accommodated therein, wherein the casing further includes a connection portion which is electrically connected with a holiday light string, the energy-saving circuit board includes a wave filter, a rectifier, a valley fill circuit, and a transformer which are arranged from a voltage input end to a voltage output end of the energy-saving circuit board. The valley fill circuit is defined between the rectifier and the wave filter so as to enhance a conduction angle of a rectifying tube and to change input currents from a spike to a waveform close to a sine wave, hence a power factor is close to above 0.7 to reduce a total harmonic distortion and an input loss, thus achieving energy saving.

### FIELD OF THE INVENTION

The present invention relates to a power adapter of an light-emitting diode (LED) light string, and move particularly to the power adapter of the LED light string having a valley-fill circuit.

### BACKGROUND OF THE INVENTION

A conventional power adapter of a holiday light string does not have an input voltage and a current synchronous valley fill circuit, thus having high work consumption. A power factor value is very low, for example, the power factor value is within 0.5 to 0.7, and the harmonic content is very high. Therefore, there is a great need for a high-efficiency, energy-saving, and low-cost LED power adapter for inventing valley-filling circuits.

The present invention has arisen to mitigate and/or obviate the afore-described disadvantages.

### SUMMARY OF THE INVENTION

The primary objective of the present invention is to provide a power adapter of an LED light string having a valley-fill circuit which is capable of reducing the input loss, saving energy, and having a low cost.

To obtain above-mentioned objectives, a power adapter of an LED light string having a valley-fill circuit provided by the present invention contains: a casing and a plug fixed on a predetermined position of the casing.

The casing includes an energy-saving circuit board accommodated therein.

The casing further includes a connection portion which is electrically connected with a holiday light string, the energy-saving circuit board includes a wave filter, a rectifier, a valley fill circuit, and a transformer which are arranged from a voltage input end to a voltage output end of the energy-saving circuit board.

The valley fill circuit is defined between the rectifier and the wave filter so as to enhance a conduction angle of a rectifying tube and to change input currents from a spike to a waveform close to a sine wave, hence a power factor is close to above 0.7 to reduce a total harmonic distortion and an input loss, thus achieving energy saving.

The rectifier includes four diodes or a bridge rectifier circuit to rectify an alternating current (AC) voltage into a pulsating direct current (DC) voltage.

The transformer is comprised of at least one coil and a magnetic core so that when the electric currents pass through the at least one coil and change, an electromagnetic induction changes the AC voltage to generate a self-inductance voltage so as to block an increase or a decrease of the electric currents.

### BRIEF DESCRIPTION OF THE DRAWINGS

FIG. 1 is a perspective view showing the assembly of a power adapter of an LED light string according to a preferred embodiment of the present invention.

FIG. 2 is a perspective view showing another assembly of the power adapter of the LED light string according to the preferred embodiment of the present invention.

FIG. 3 is a perspective view showing another assembly of the power adapter of the LED light string according to the preferred embodiment of the present invention.

FIG. 4 is a perspective view showing another assembly of the power adapter of the LED light string according to the preferred embodiment of the present invention.

FIG. 5 is a side plan view showing the application of the power adapter of the LED light string according to the preferred embodiment of the present invention.

FIG. 6 is another side plan view showing the application of the power adapter of the LED light string according to the preferred embodiment of the present invention.

FIG. 7 is also another side plan view showing the application of the power adapter of the LED light string according to the preferred embodiment of the present invention.

FIG. 8 is still another side plan view showing the application of the power adapter of the LED light string according to the preferred embodiment of the present invention.

FIG. 9 is another side plan view showing the application of the power adapter of the LED light string according to the preferred embodiment of the present invention.

FIG. 10 is also another side plan view showing the application of the power adapter of the LED light string according to the preferred embodiment of the present invention.

FIG. 11 is a block diagram showing the assembly of an energy-saving circuit board of the power adapter of the LED light string according to the preferred embodiment of the present invention.

FIG. 12 is a circuit diagram showing the assembly of the energy-saving circuit board of the power adapter of the LED light string according to the preferred embodiment of the present invention.

### DETAILED DESCRIPTION OF THE PREFERRED EMBODIMENTS

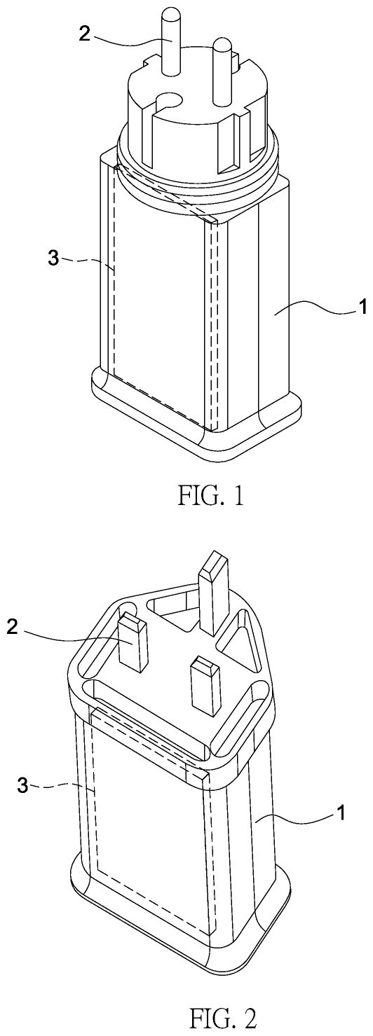

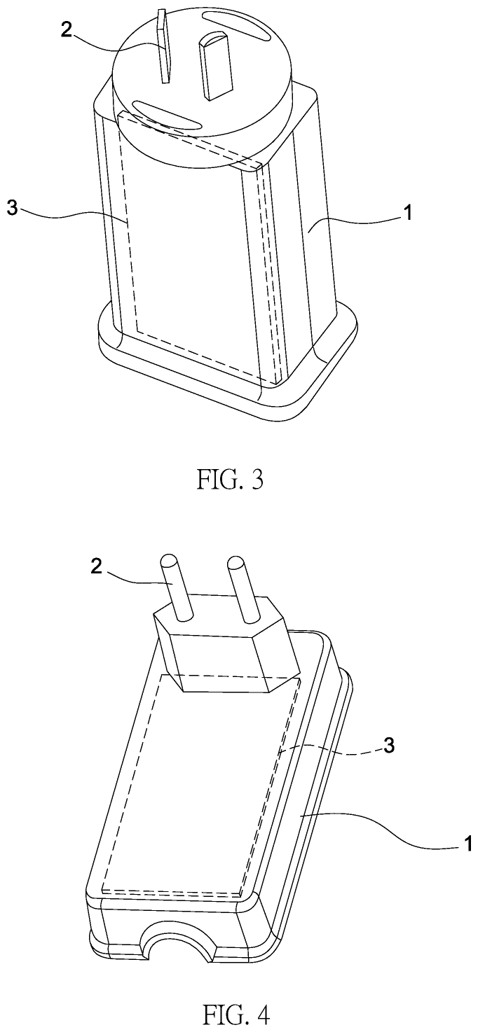

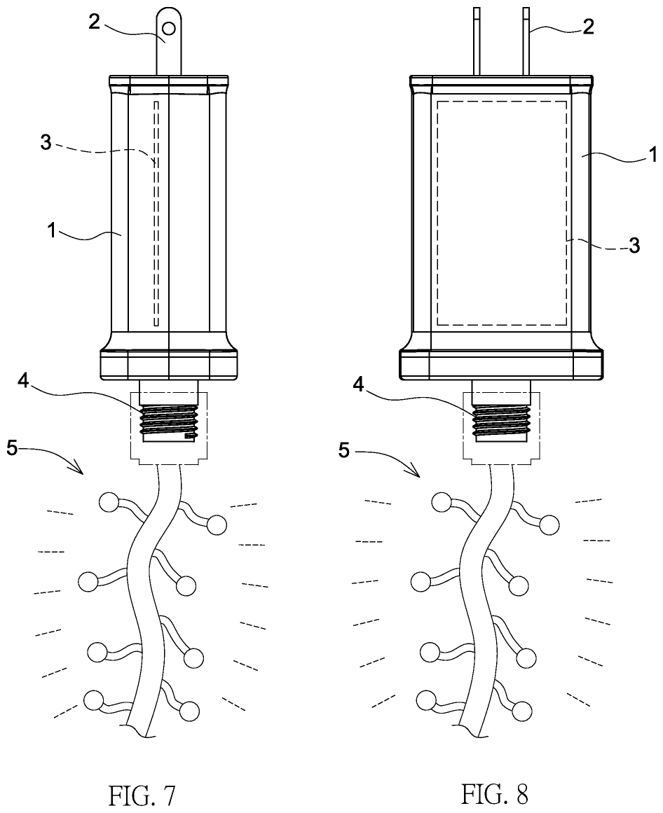

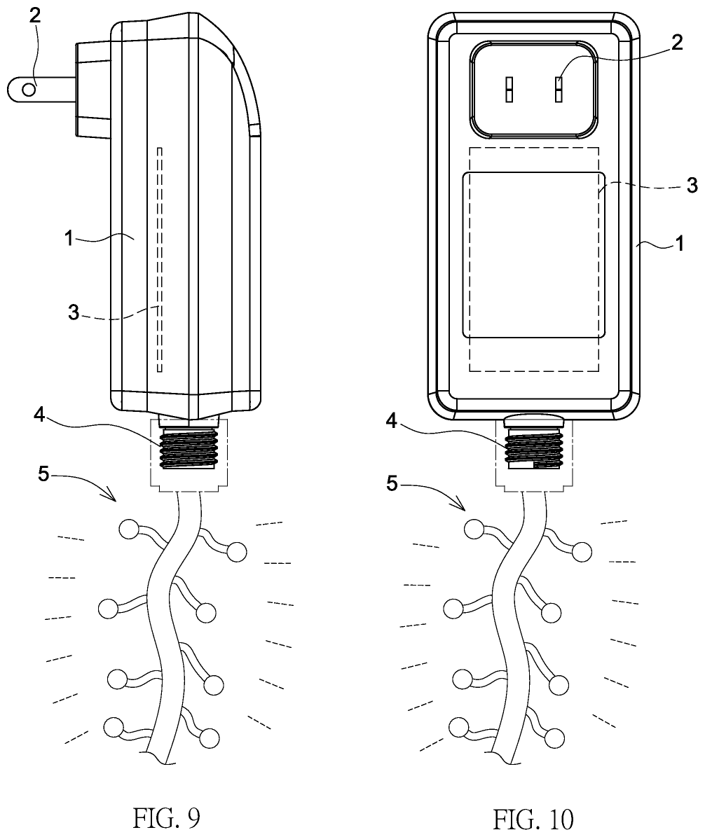

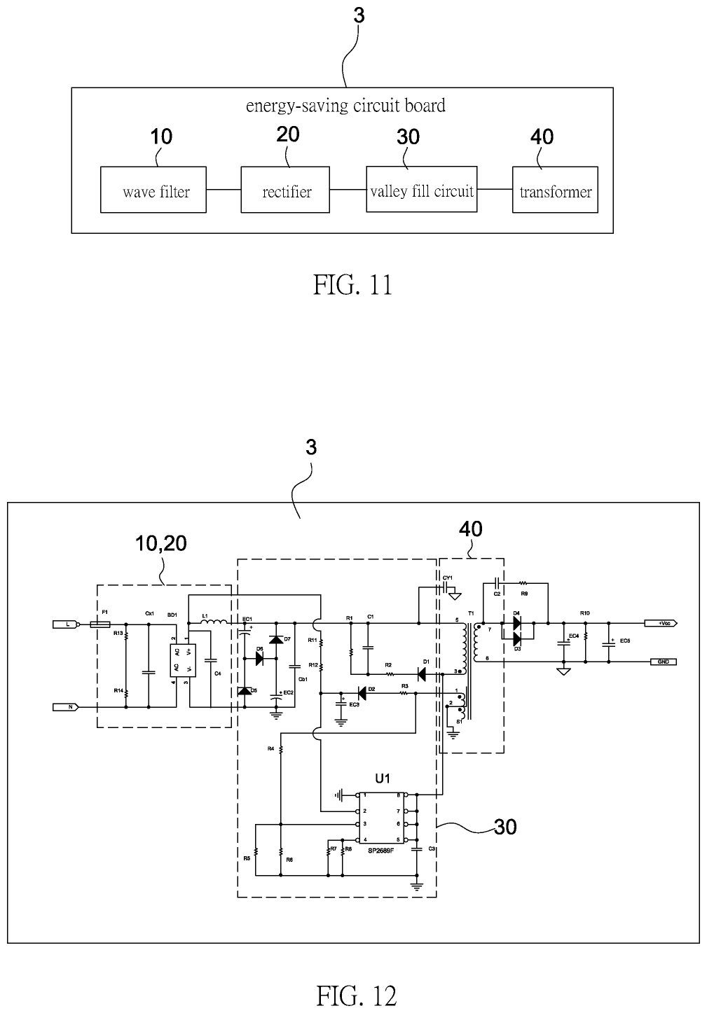

With reference to FIGS. 1-12, a power adapter of a (light-emitting diode) LED light string having a valley-fill circuit according to a preferred embodiment of the present invention comprises: a casing 1 and a plug 2 fixed on a predetermined position of the casing 1.

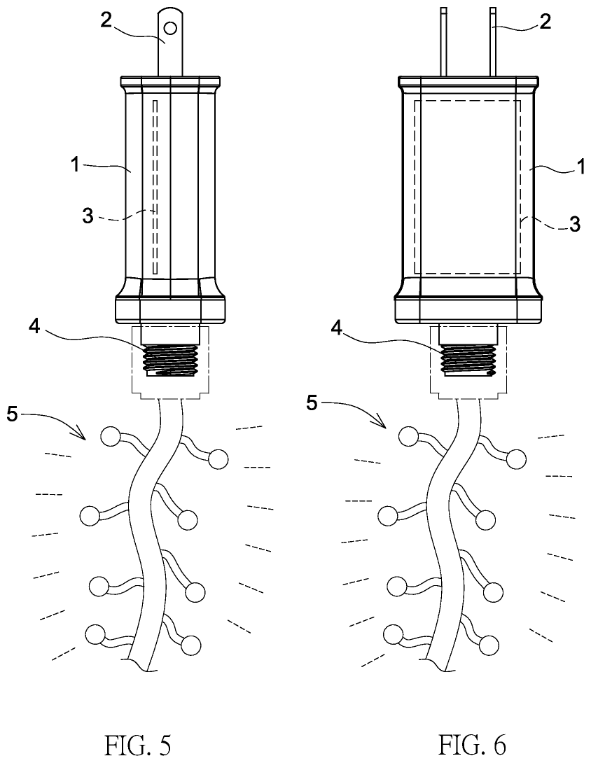

FIGS. 1-4 are a perspective view showing various assemblies of the power adapter of the LED light string according to the preferred embodiment of the present invention, wherein the power adapter has an in-line plug as shown in FIGS. 1-3, and the power adaptor has a splayed plug as shown in FIG. 4. The casing 1 includes an energy-saving circuit board 3 accommodated therein. FIGS. 5-10 are a perspective view showing various applications of the power adapter of the LED light string according to the preferred embodiment of the present invention, wherein the casing 1 further includes a connection portion 4 which is electrically connected with a holiday light string 5, the energy-saving circuit board 3 includes a wave filter 10, a rectifier 20, a valley fill circuit 30, and a transformer 40 which are arranged from a voltage input end to a voltage output end of the energy-saving circuit board 3.

The valley fill circuit 30 is defined between the rectifier 20 and the wave filter 10 so as to enhance a conduction angle of a rectifying tube and to change input currents from a spike to a waveform close to a sine wave, hence a power factor is close to above 0.7 to reduce a total harmonic distortion and an input loss, thus achieving energy saving.

The rectifier 20 includes four diodes or a bridge rectifier circuit to rectify an alternating current (AC) voltage into a pulsating direct current (DC) voltage, thus modulating the DC voltage via a switch efficiently.

Preferably, the transformer 40 is comprised of at least one coil and a magnetic core so that when the electric currents pass through the at least one coil and change, an electromagnetic induction changes the AC voltage to generate a self-inductance voltage so as to block an increase or a decrease of the electric currents.

Accordingly, the power adapter of the present invention has advantages as follows:

1) Reducing the input loss;

2) Saving energy; and

3) Having a low cost.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A power adapter of an LED light string having a valley-fill circuit comprising:
a casing and a plug fixed on a predetermined position of the casing;
wherein the casing includes an energy-saving circuit board accommodated therein, wherein the casing further includes a connection portion which is electrically connected with a holiday light string, the energy-saving circuit board includes a wave filter, a rectifier, a valley fill circuit, and a transformer which are arranged from a voltage input end to a voltage output end of the energy-saving circuit board;
wherein the valley fill circuit is defined between the rectifier and the wave filter so as to enhance a conduction angle of a rectifying tube and to change input currents from a spike to a waveform close to a sine wave, wherein a power factor is close to above 0.7 to reduce a total harmonic distortion and an input loss, thus achieving energy saving.

2. The power adapter of the LED light string as claimed in claim 1, wherein the rectifier includes four diodes or a bridge rectifier circuit to rectify an alternating current voltage into a pulsating direct current voltage.

3. The power adapter of the LED light string as claimed in claim 1, wherein the transformer is comprised of at least one coil and a magnetic core so that when the electric currents pass through the at least one coil and change, an electromagnetic induction changes the AC voltage to generate a self-inductance voltage so as to block an increase or a decrease of the electric currents.
